(19) United States
(12) Patent Application Publication
(10) Pub. No.: US 2022/0009422 A1
(43) Pub. Date: Jan. 13, 2022

(54) METHOD, APPARTUS, AND SYSTEM FOR SECURING A MOBILE DEVICE IN A VEHICLE

(71) Applicant: Tuan NGUYEN, Rockville, MD (US)

(72) Inventor: Tuan NGUYEN, Rockville, MD (US)

(21) Appl. No.: 17/370,771

(22) Filed: Jul. 8, 2021

Related U.S. Application Data
(60) Provisional application No. 63/049,429, filed on Jul. 8, 2020.

(51) Int. Cl. B60R 11/02

(52) U.S. Cl. CPC B60R 11/0241; H04B 1/3877

(57) ABSTRACT

An apparatus comprises an adjustable base structure an adjustable base structure having a joint structure extending therefrom, wherein the adjustable base structure is configured to be affixed between two or more dashboard instruments of a vehicle. The apparatus further comprises a joint structure extending from the adjustable base structure.

### RELATED APPLICATIONS

This application claims the benefit of U.S. Provisional Patent Application No. 63/049,429, titled “Method, Apparatus, and System for Securing a Mobile Device in a Vehicle,” filed Jul. 8, 2020, the entire disclosure of which is hereby incorporated by reference herein.

### BACKGROUND

Drivers rely on their mobile devices (e.g., smartphones, tablet devices, etc.) for assistance with vehicular navigation, communications, and interacting with various applications. However, automotive manufacturers as well as mobile device accessories manufacturers have not adequately provided for affixing such mobile devices within the instrumentation areas. An inappropriately placed mobile device holder can make utilizing mobile devices for navigation cumbersome and dangerous. Conventional holders are generally secured either along the windshield or within air vents of the vehicle, resulting in the driver having to divert attention about from the road and from the instrument clusters. With a windshield mount, the drivers' vision is obstructed by the mounting unit as well as the charging cable to power the mobile device, and thus, poses a driving hazard. A holder deployed using the air vents impedes the airflow; and if the heat is on, it can change the temperature of the mobile device as to negatively impact its proper function. In either case, these mounting units are not ideally positioned near the instrumentation panel, where the drivers' eyes are generally drawn to, but requires the drivers to glance at another location. Depending on the position of the mount, such a need to look around the car cabin presents a serious distraction.

### SOME EXAMPLE EMBODIMENTS

Therefore, there is a need for a mobile device holder (or mount) that can be suitably placed within the proximity of the dashboard.

Additional aspects and other features of the present disclosure will be set forth in the description which follows and in part will be apparent to those having ordinary skill in the art upon examination of the following or may be learned from the practice of the present disclosure. The advantages of the present disclosure may be realized and obtained as particularly pointed out in the appended claims.

According to the present disclosure, some technical effects may be achieved in part by an apparatus comprising: an adjustable base structure having a joint structure extending therefrom, wherein the adjustable base structure is configured to be affixed between two or more dashboard instruments of a vehicle; and a joint structure extending from the adjustable base structure.

Another aspect of the apparatus includes a holder member affixed to the joint structure, wherein the holder member is configured to receive the mobile device. Other aspects include the holder member comprising adjustable arms to clasp the mobile device; the holder member is padded with silicone for contact with the mobile device. Another aspect includes the adjustable base structure being wedge-shaped and tapering to adaptively fit between the two or more dashboard instruments. Other aspects include the joint structure has a spherical end opposite from the adjustable base structure. A further aspect includes the adjustable base structure is wedge-shaped and tapers to adaptively fit between the two or more dashboard instruments. Another aspect includes a side surface of the wedge-shaped adjustable base structure comprises securing means that securely attaches to the two or more dashboard instruments; wherein the apparatus comprises of a hard rubber material that conforms to fit between the two or more dashboard instruments. A further aspect includes the apparatus being removable from the two or more dashboard instruments.

Additional aspects and technical effects of the present disclosure will become readily apparent to those skilled in the art from the following detailed description wherein embodiments of the present disclosure are described simply by way of illustration of the best mode contemplated to carry out the present disclosure. As will be realized, the present disclosure is capable of other and different embodiments, and its several details are capable of modifications in various obvious respects, all without departing from the present disclosure. Accordingly, the drawings and description are to be regarded as illustrative in nature, and not as restrictive.

### BRIEF DESCRIPTION OF THE DRAWINGS

The present disclosure is illustrated by way of example, and not by way of limitation, in the figures of the accompanying drawing and in which like reference numerals refer to similar elements and in which:

FIG. 1A is a back view of a mobile device holder, according to one example embodiment;

FIG. 1B is a front view of a mobile device holder, according to one example embodiment;

FIG. 1C is a top view of a mobile device holder, according to one example embodiment;

FIGS. 1 D-E are perspective views of a mobile device holder, according to one example embodiment;

FIGS. 1 F-G are perspective views of a mobile device holder in which the joint structure has hollowed sections, according to one example embodiment;

FIGS. 1 H-J illustrate a mobile device holder with a device holder attachment, according to one example embodiment;

FIG. 1K illustrates a mobile device holder affixed among an instrument (or dashboard) cluster, according to one example embodiment;

FIG. 1L is a diagram of a process of forming the mobile device holder, according one example embodiment;

FIG. 2 illustrates a mobile device attached to a mobile device holder, according to one example embodiment; and

FIGS. 3 A-C illustrate a mobile device attached to a mobile device holder that is affixed to a dashboard of a vehicle, according to one example embodiment.

### DETAILED DESCRIPTION

In the following description, for the purposes of explanation, numerous specific details are set forth in order to provide a thorough understanding of exemplary embodiments. It should be apparent, however, that exemplary embodiments may be practiced without these specific details or with an equivalent arrangement. In other instances, well-known structures and devices are shown in block diagram form in order to avoid unnecessarily obscuring exemplary embodiments. In addition, unless otherwise indicated, all numbers expressing quantities, ratios, and numerical properties of ingredients, reaction conditions, and so forth used in the specification and claims are to be understood as being modified in all instances by the term “about.”

The present disclosure addresses and solves the current problems of mobile device holders blocking the vision of a driver because it is either mounted in front of a windshield or its position and direction cannot be adjusted to match the line-of-sight of the driver. Additionally, conventional holders disrupt the aesthetics of the vehicle cabin. These problems are addressed by forming an adjustable mobile device holder that can be affixed between a first portion of a vehicle dashboard and a second portion of the vehicle dashboard.

Still other aspects, features, and technical effects will be readily apparent to those skilled in this art from the following detailed description, wherein preferred embodiments are shown and described, simply by way of illustration of the best mode contemplated. The disclosure is capable of other and different embodiments, and its several details are capable of modifications in various obvious respects. Accordingly, the drawings and descriptions are to be regarded as illustrative in nature, and not as restrictive.

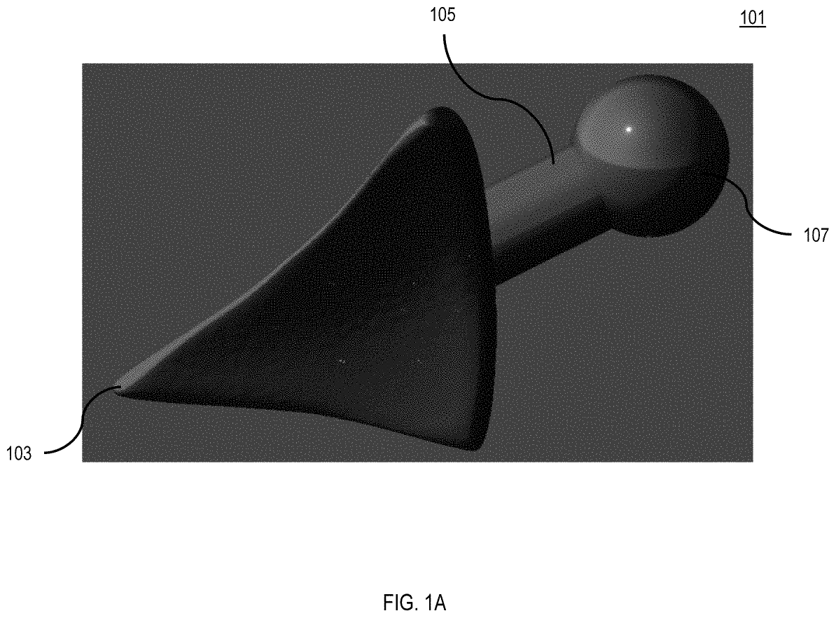

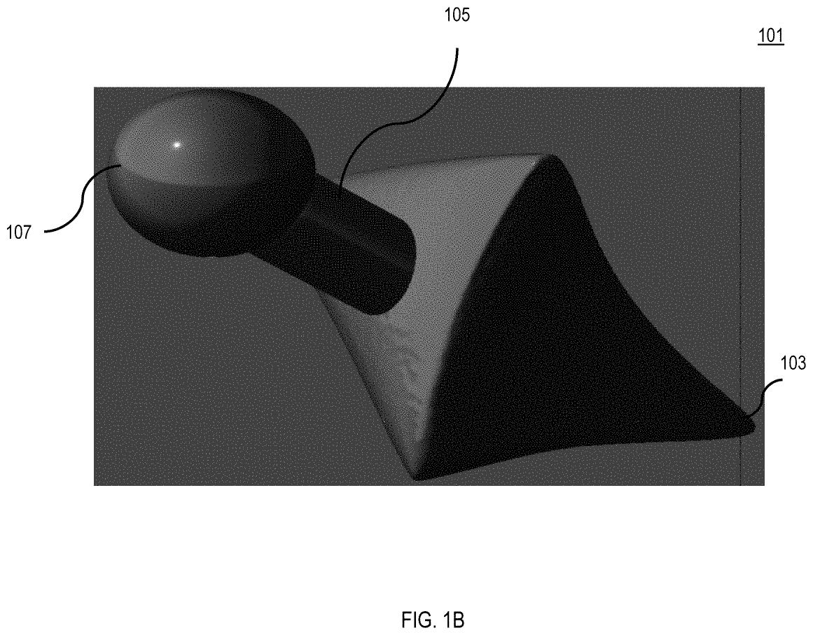

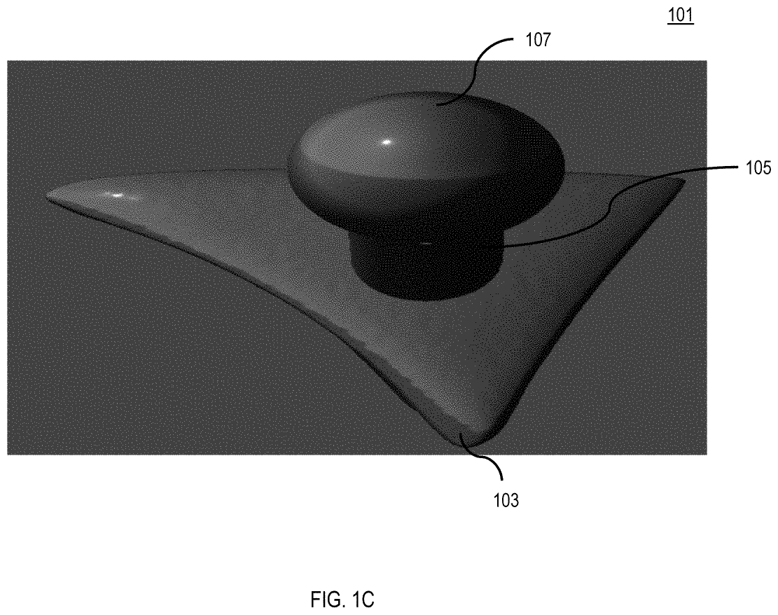

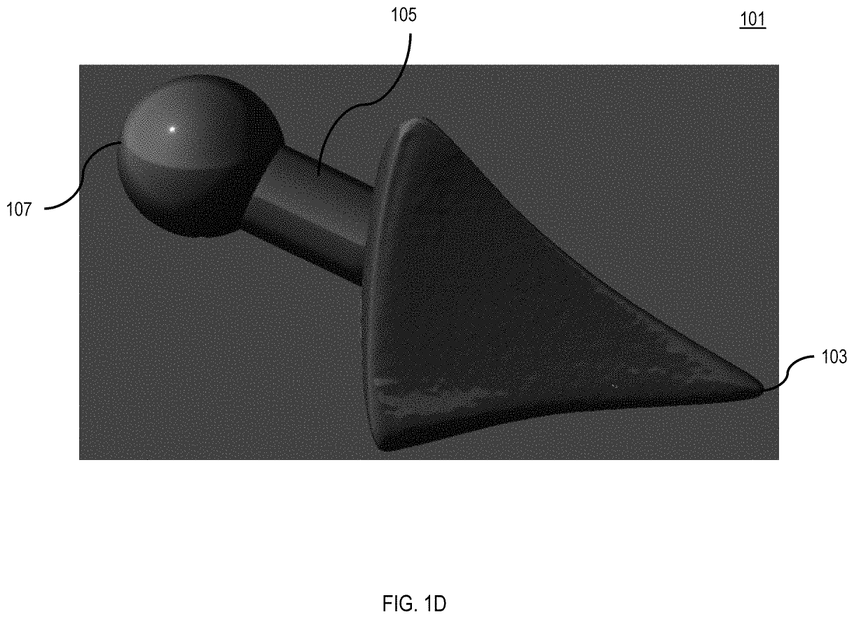

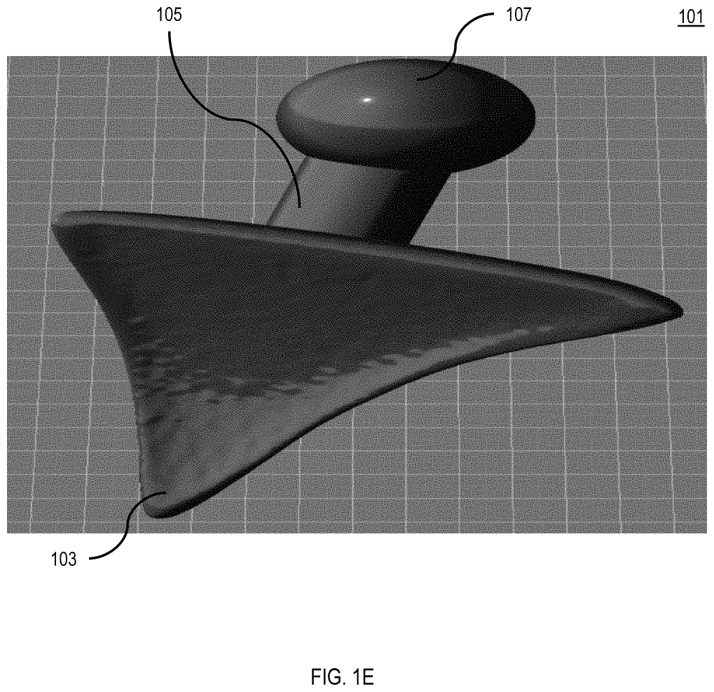

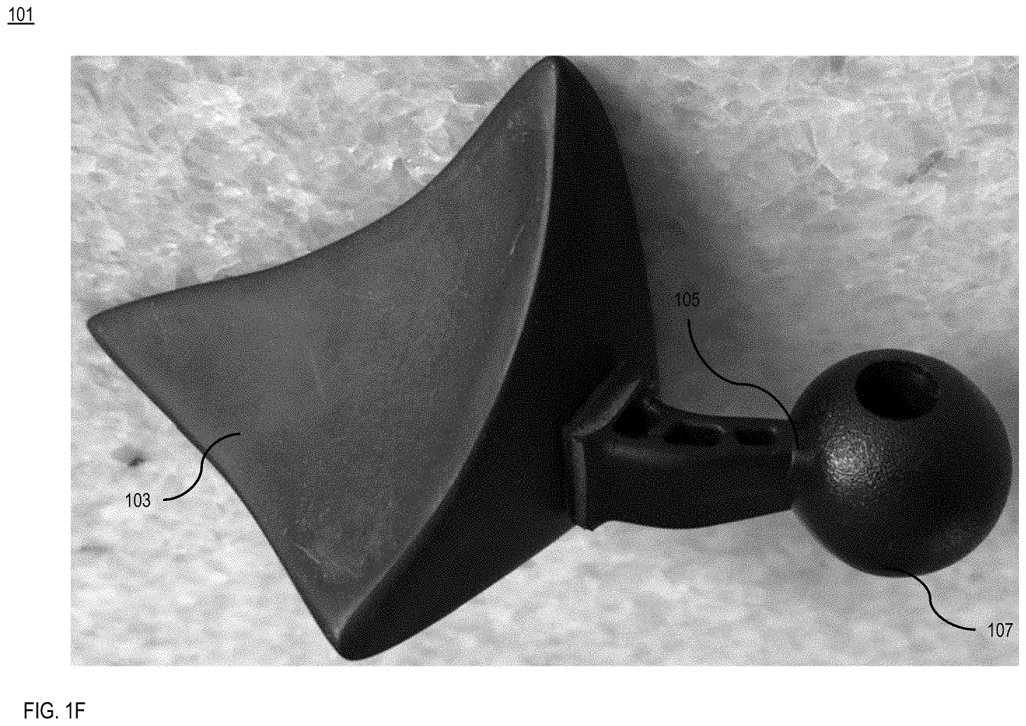

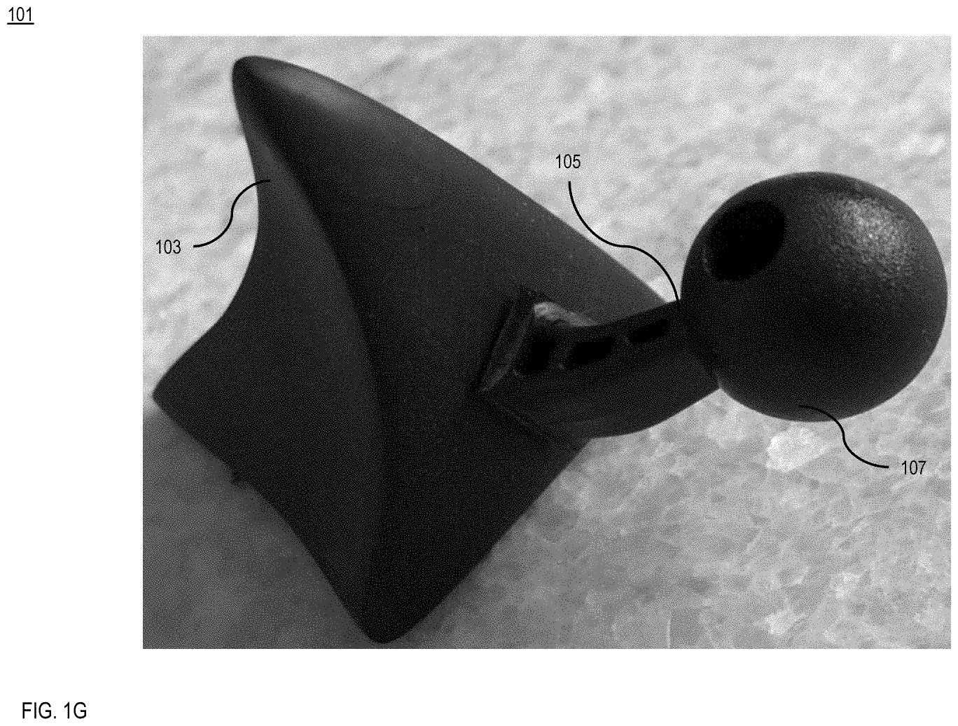

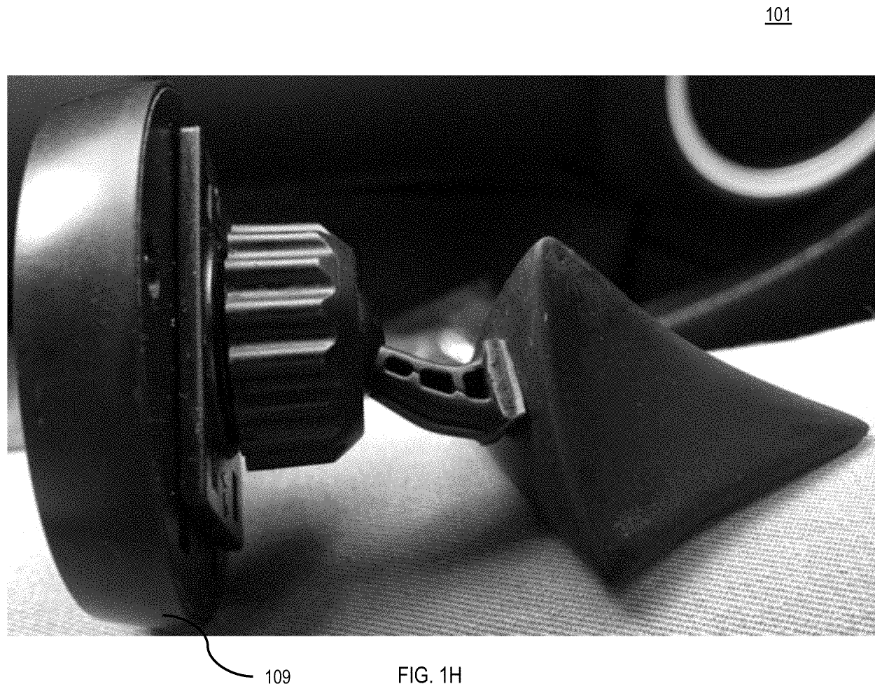

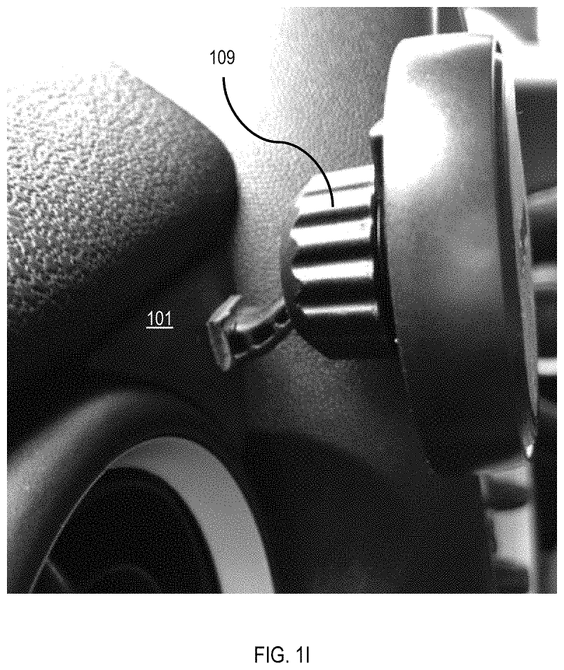

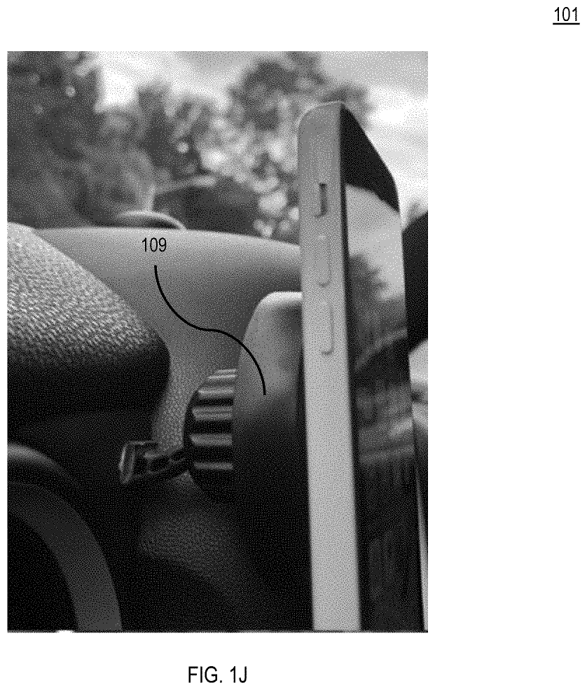

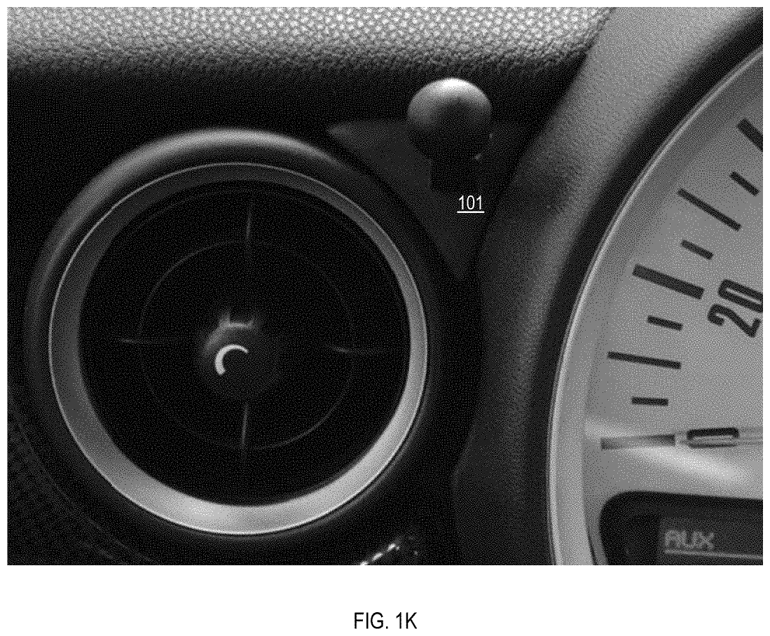

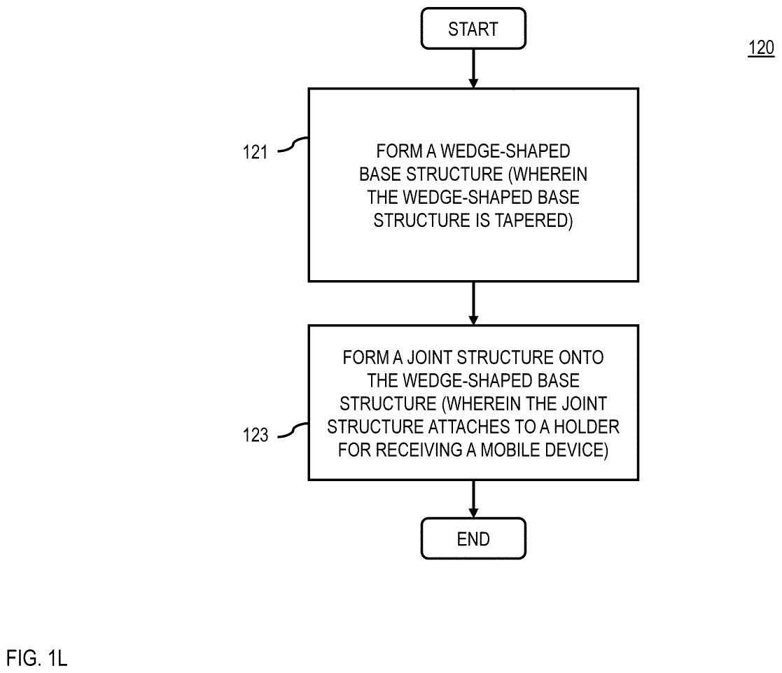

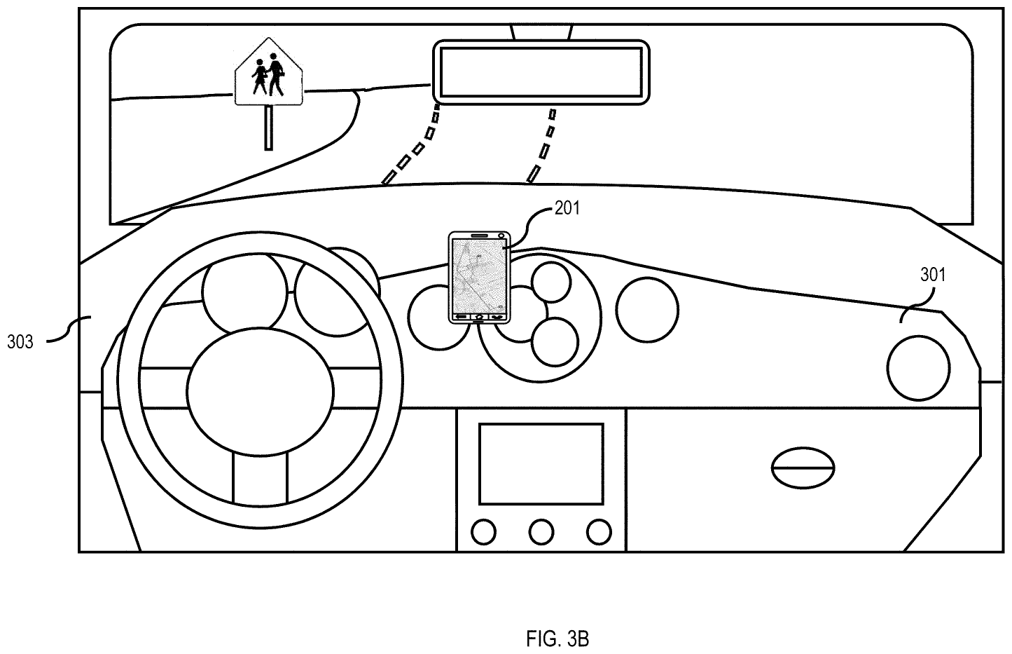

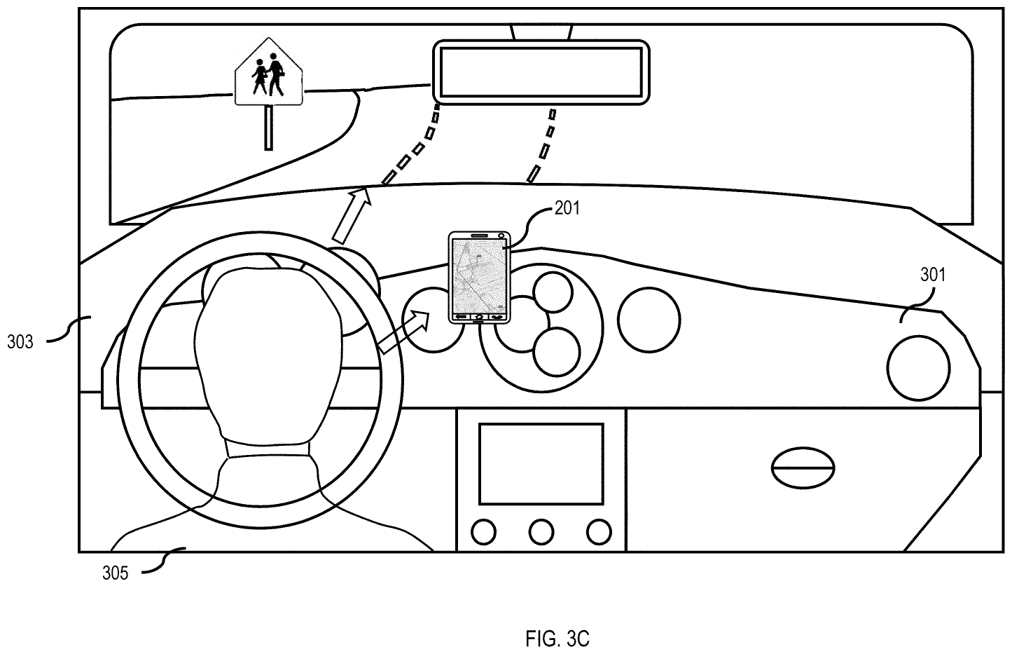

FIG. 1A is a back view of a mobile device holder, according to one example embodiment. In one embodiment, the mobile device holder 101 comprises a base structure 103 that is configured to be mounted in-between the spaces of a dashboard of a vehicle (e.g., automobile, motorcycle, golf cart, All-Terrain Vehicle (ATV), etc.). The base structure 103 is adjustable in that in can be inserted or affixed variably in depth to allow for a secure fit among an instrument cluster of a vehicle dashboard; moreover, the adjustability can stem from the flexibility of the material of the base structure. The instrument cluster can include two or more protruding portions or two or more instruments (e.g., gauges or protruding air vents, etc.), or any combination, as will be later described with respect to FIGS. 3A-3C. As shown, the adjustable base structure 103 is wedge-shaped; however, it is contemplated the shape may vary depending on the design of the instrumentation panel or dashboard so as to position the structure 103 between distinct protrusions of the dashboard and as close to the proximity of the key instruments—e.g., gauges, such as the odometer. By way of example, the shapes of the structure 103 can be a pentagon, octagon, or other polygons, whereby one or more of the sides can be of different lengths to fit between gauges. In one embodiment, the wedge-shaped base structure 103 is tapered, and comprises edges that are adapted to fit underneath the spaces of the dashboard. The side surfaces of the adjustable base structure 103 can have securing means, e.g., suction cups (or other securing mechanisms), that securely attaches to the in-between spaces of a first portion and a second portion of the dashboard. That is, the vehicle dashboard can include various protruding portions or sections, as explained.

The mobile device holder 101 can also comprise a cylindrical shaped joint structure 105 (which, in one embodiment, can be made adjustable with respect to length, flexibility, or both); however, other shapes may be utilized. This cylindrical shaped adjustable joint structure 105 attaches base structure 103 and has a spherical end 107 together. It is noted that the spherical end 107 can be formed as part of the joint structure 105 or be a separate piece. Furthermore, adjustable joint structure 105 extends and pivots to set a desired viewing angle for the users. The spherical end 107 provides an in-built slot to house magnets that can attach to a mobile device, according to one embodiment, via a holder member (shown in FIGS. 1 H-J). In another embodiment, the holder member comprises adjustable arms padded with silicone to smoothly clasp, as to accommodate mobile devices of different dimensions. In various embodiments, the mobile device holder 101 is formed using materials with rigidity, such as metals, alloys, rubber, plastics, wood, etc.; such consideration can be based on the aesthetics of the exterior of the vehicle and/or its interior cabin.

FIG. 1B is a front view of a mobile device holder, according to one example embodiment. In one embodiment, the spherical end 107 is formed of a rubber material that permanently houses a powerful magnet, e.g., N52 magnet or any suitable magnet, to securely hold the mobile devices even in rough road conditions or strong mechanical vibrations and jolting which occur when a vehicle is in motion. The rubber material provides a frictional resistance, compliments the magnet, and prevents the mobile devices from slipping. Such magnetic spherical end 107 is versatile since it is compatible with almost any model of mobile devices, e.g., magnetic spherical end 107 attracts the cell phone by means of its cover, e.g., metal casing, securing it in the required position. It is noted that some conventional mobile device holders have the added inconvenience of scratching the mobile devices at the points where they touch the mobile devices, and which tend to become deep scratches. To address this issue, one embodiment, the spherical end 107 comprises securing means (e.g., adjustable arms) that is padded with silicone to smoothly clasp the mobile devices.

FIG. 1C is a top view of a mobile device holder, according to one example embodiment. Some of the current mobile device holders require drilling holes on the dashboard of a vehicle in order to secure them. To address this issue, mobile device holder 101 is configured to be mounted in-between and/or underneath the spaces of a dashboard of a vehicle. As depicted, the spherical end 107 of the holder 101 is shaped to comfortably fit in the palm of a user. The user can simply grab the spherical end 107 and then exert force to slide the mobile device holder 101 in-between and/or underneath the spaces of distinct protrusions of the dashboard; whereby the driver can employ a single-handed operation.

FIGS. 1 D-E are perspective views of a mobile device holder, according to one example embodiment. FIGS. 1 F-G are perspective views of a mobile device holder in which the joint structure has hollowed sections, according to one example embodiment. As depicted, the joint structure 105 is flexible and can contain hollowed sections to reduce weight and material costs. Similarly, the spherical end 107 can be hollowed.

FIGS. 1 H-J illustrate a mobile device holder with a holder member, according to one example embodiment. As shown, holder member 109 can be fixed on the spherical end 107. It is contemplated that any type of holder member can be utilized to hold or secure the mobile phone; for example, the holder member 109 can have adjustable members or arms horizontally and vertically to hold the sides of the mobile device.

FIG. 1K illustrates a mobile device holder affixed among an instrument (or dashboard) cluster, according to one example embodiment. Process 120 involves forming a wedge-shaped base structure 103 that is tapered (per step 121). A join structure 105 is formed, as in step 123, onto the wedge-shaped base structure. In various embodiments, the joint structure has a spherical end 107, it is contemplated that the end 107 may be formed in any shape to directly or indirectly contact the mobile device. As illustrated in the various FIGS. 1 A-K, the tapering of the base structure is opposite of the spherical end 107.

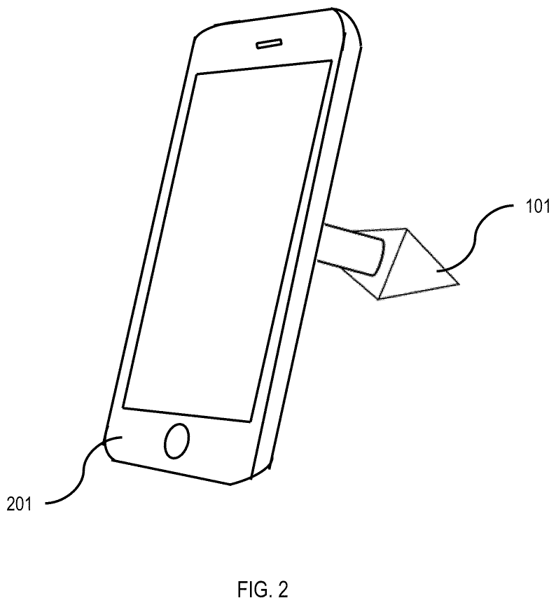

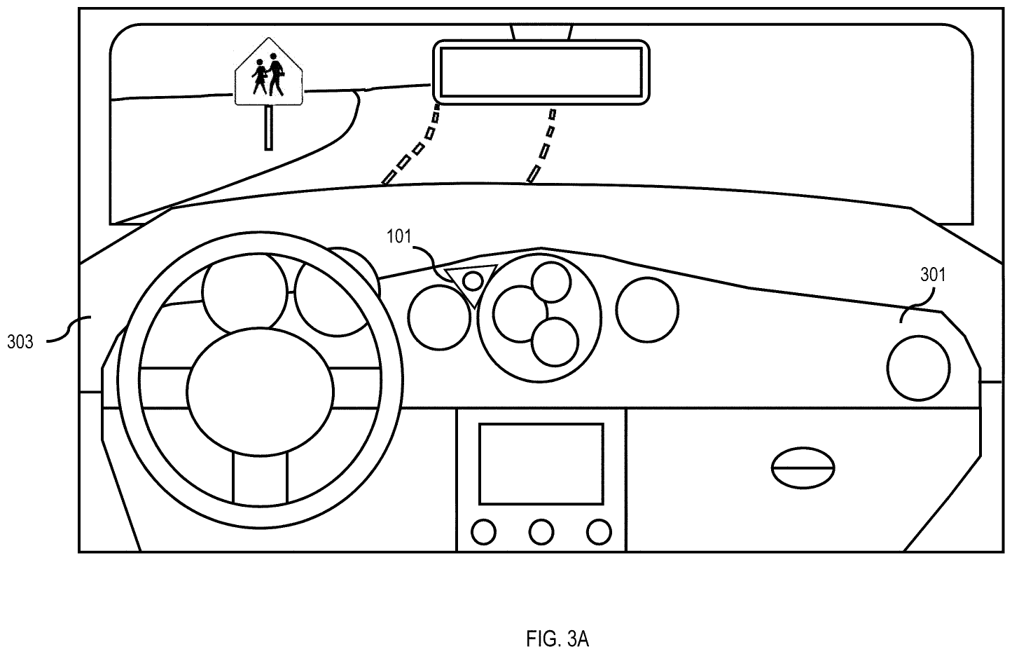

FIG. 2 illustrates a mobile device attached to a mobile device holder, according to one example embodiment. In one embodiment, a mobile device 201 is any type of mobile handset, multimedia tablet, communicator, notebook, personal communication system (PCS) device, a personal navigation device, personal digital assistants (PDAs), audio/video player, digital camera/camcorder, positioning device, television receiver, radio broadcast receiver, electronic book device, game device, or any combination thereof. Additionally, any accessories (e.g., protective covers) or peripherals of these mobile devices, although not shown, can also be supported by the holder 101. In one embodiment, mobile device 201 is attached to a mobile device holder 101 via magnets, adhesives, or other mechanisms. For example, the back surface of mobile device 201 (or a protective cover) may provide a metal or magnetic material that is attracted by a magnet housed in spherical end 107. The powerful magnet housed in spherical end 107 may securely hold mobile device 201 via a holder member affixed to the spherical end 107 (as shown in FIGS. 1 H-J) or alternatively, the holder member can be made as part of a protective cover for the mobile device 201 or be a holder member directly attached to the device. It is noted that the magnetic forces that affix the device 201 to the spherical end 107 should be magnetically shielded from the sensitive electronics of the mobile device 201.

FIGS. 3 A-C illustrate a mobile device attached to a mobile device holder that is affixed to a dashboard of a car, according to one example embodiment. As previously discussed, it is inconvenient to mount a mobile device holder on a windshield or within air vents of a vehicle. Furthermore, drilling holes on the dashboard of a vehicle to secure the mobile device holders is undesirable approach that damages the design of a vehicle, and thus, devalues the vehicle. Therefore, FIG. 3A illustrates a scenario wherein mobile device holder 101 is positioned within the instrumentation panel of a vehicle, an area where drivers' eyes are generally drawn to. In FIG. 3A, adjustable base structure 103 is mounted in-between a first protruding portion and a second protruding portion of dashboard 301 of vehicle 303. In one embodiment, the first portion of dashboard 301 is a circular air vent, however, the shape may vary per design of the instrumentation panel. In one embodiment, the second portion of dashboard 301 is a circular display unit, e.g., speedometer, however, the shape may vary per design of the instrumentation panel.

Considering that drivers enter and exit their vehicles frequently, the process of inserting and removing the mobile devices from a holder should not be an arduous task, e.g., it is inconvenient for drivers to be extra cautious every time they insert the mobile devices into the holder to prevent scratches. FIG. 3B shows a simple and quick way of attaching mobile device 201 to mobile device holder 101 that is affixed to dashboard 301 of vehicle 303. In one embodiment, mobile device 201 is attached to a mobile device holder 101 via magnets, i.e., the back surface of mobile device 201 may comprise of metal or magnetic material that is attracted by the magnet housed in spherical end 107 or a holder member 109 (of FIGS. 1 H-J). In another embodiment, mobile device 201 is attached to a mobile device holder 101 via other securing means. For example, a reusable adhesive can be applied the top surface of spherical end 107 may contact the back of the mobile device 201. In a further embodiment, spherical end 107 may comprise adjustable arms padded with silicone to smoothly and securely clasp mobile device 201. Alternatively, holder member 109 can be utilized and provide such adjustable arms.

Referring to FIG. 3C, cylindrical-shaped adjustable joint structure 105 extends and curtails to give an ideal viewing angle to driver 305. In one embodiment, adjustable joint structure 105 can pivot up or down for a variety of angles which optimizes viewing capabilities. In such a manner, driver 305 can position mobile device 201 at an angle that matches his line-of-sight, thereby enjoy a more relaxed and safer drive.

In the preceding description, the present disclosure is described with reference to specifically exemplary embodiments thereof. It will, however, be evident that various modifications and changes may be made thereto without departing from the broader spirit and scope of the present disclosure, as set forth in the claims. The specification and drawings are, accordingly, to be regarded as illustrative and not as restrictive. It is understood that the present disclosure is capable of using various other combinations and embodiments and is capable of any changes or modifications within the scope of the inventive concept as expressed herein.

What is claimed is:

1. An apparatus comprising:
an adjustable base structure having a joint structure extending therefrom, wherein the adjustable base structure is configured to be affixed between two or more dashboard instruments of a vehicle; and
a joint structure extending from the adjustable base structure.

2. The apparatus of claim 1, further comprising:
a holder member affixed to the joint structure, wherein the holder member is configured to receive the mobile device.

3. The apparatus of claim 2, wherein the holder member comprises adjustable arms to clasp the mobile device.

4. The apparatus of claim 2, wherein the holder member is padded with silicone for contact with the mobile device.

5. The apparatus of claim 2, wherein the joint structure has a spherical end opposite from the adjustable base structure.

6. The apparatus of claim 1, wherein the adjustable base structure is wedge-shaped and tapers to adaptively fit between the two or more dashboard instruments.

7. The apparatus of claim 6, wherein a side surface of the wedge-shaped adjustable base structure comprises securing means that securely attaches to the two or more dashboard instruments.

8. The apparatus of claim 7, wherein the securing means includes one or more suction cups.

9. The apparatus of claim 1, wherein the apparatus comprises of a hard rubber material that conforms to fit between the two or more dashboard instruments.

10. The apparatus of claim 1, wherein the apparatus is removable from the two or more dashboard instruments.

11. A system for holding a mobile device, comprising:
a wedge-shaped base structure configured to be secured between a first dashboard instrument of a vehicle dashboard and a second dashboard instrument of the vehicle dashboard;
a joint structure coupled to the wedge-shaped base structure; and
a holder member affixed to the joint structure for receiving the mobile device to be situated between the first dashboard instrument and the second dashboard instrument.

12. The system of claim 11, wherein the holder member comprises adjustable arms to clasp the mobile device of different dimensions.

13. The system of claim 12, wherein the adjustable arms are padded with silicone for smooth contact with the mobile device.

14. The system of claim 11, wherein the holder member is formed as part of the joint structure.

15. The system of claim 11, wherein the wedge-shaped base structure tapers to adaptively fit between the first dashboard instrument and the second dashboard instrument.

16. The system of claim 15, wherein a side surface of the wedge-shaped base structure comprises securing means that securely affixes to the first dashboard instrument and the second dashboard instrument.

17. The system of claim 16, wherein the securing means includes one or more suction cups.

18. The system of claim 11, wherein the wedge-shaped base structure comprises of a rubber material that conforms to fit between the two or more dashboard instruments.

19. The system of claim 1, wherein the system is removable from the two or more dashboard instruments.

20. A method of constructing an apparatus to hold a mobile device, comprising:
forming a wedge-shaped base structure; and
forming a joint structure onto the wedge-shaped base structure,
wherein the wedge-shaped base structure is tapered towards an end away from the joint structure to provide being securely affixed between a first dashboard instrument of a vehicle dashboard and a second dashboard instrument of the vehicle dashboard.
